(19) United States
(12) Patent Application Publication
(10) Pub. No.: US 2010/0080094 A1
(43) Pub. Date: Apr. 1, 2010

(54) DISPLAY APPARATUS AND CONTROL METHOD THEREOF

(75) Inventor: Hyun-ah Sung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/557,125

(22) Filed: Sep. 10, 2009

(30) Foreign Application Priority Data
Sep. 30, 2008 (KR) 10-2008-0096240

(51) Int. Cl. G11B 19/02

(52) U.S. Cl. 369/47.1; G9B/19.001

(57) ABSTRACT

Disclosed are a display apparatus and a control method thereof. The display apparatus includes a memory which stores contents with voice information; a voice output unit which outputs a voice; a voice storage which receives and stores a voice of a user; and a controller which controls the voice output unit to selectively output one of the voice information stored in the memory or the voice of a user stored in the voice storage when reproducing the contents.

### CROSS-REFERENCE TO RELATED APPLICATION

This application claims priority from Korean Patent Application No. 10-2008-0096240, filed on Sep. 30, 2008 in the Korean Intellectual Property Office, the disclosure of which is incorporated herein by reference.

### BACKGROUND OF INVENTION

1. Field of Invention

Apparatuses and methods consistent with the present invention relate to a display apparatus and a control method thereof, and more particularly to a display apparatus and control method which can record a user's voice and output the voice as being mixed with content.

2. Description of the Related Art

In general, a display apparatus such as a digital television (DTV) or similar devices support functions of displaying internal or external multimedia contents of the TV These contents may belong to the fields of cooking, sports, a child, a game, a living, a gallery, etc. A menu for each field is moved and selected by a wheel key or four-arrow keys of a remote controller.

In the case of a gallery, picture files are reproduced in a slideshow, and thus there is no room for allowing a user to interact with the reproduction. Further, in the case of paper folding, cooking or yoga, a user may follow a program on the TV, but a user's reaction is not reflected in the TV On the other hand, in the case of a game or like contents to which a user's selection can be input, it supports a user's interaction only on a simple level, where the existing four-arrow keys or wheel key can be employed in move and selection or text input.

However, a related art display apparatus does not arouse interest of a user since it only allows a user's interaction at a simple level with regard to the multimedia contents. Particularly, in case of contents related to language study, a user cannot listen to his/her voice through the TV again, thereby deteriorating educational effect.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a display apparatus which can record a user's voice and output the voice mixed with contents, and thus in a particular case of contents related to language study, educational effect and interest of a user can be increased.

The present invention also provides a control method of a display apparatus, which can record a user's voice and output the voice mixed with contents, and thus in a particular case of contents related to language study, educational effect and interest of a user can be increased.

According to an aspect of the present invention, there is provided a display apparatus including: a memory which stores contents with voice information; a voice output unit which outputs a voice; a voice storage which receives and stores a voice of a user; and a controller which controls the voice output unit to selectively output one of the voice information stored in the memory and the voice of a user stored in the voice storage when reproducing the contents.

The display apparatus may further include a selector which selects one of the voice information stored in the memory and the voice of a user stored in the voice storage before reproducing the contents.

The memory may further store subtitle information corresponding to the voice information; and the display apparatus may further include an image output unit which displays the subtitle information when reproducing the contents.

The contents may include contents for studying a foreign language.

The subtitle information and the voice information may include identification (ID) given for distinguishing a unit of words or sentences; and the controller may control the voice storage to store the voice of a user in correspondence to the ID.

The subtitle information and the voice information may include a plurality of conversations between speaking persons; and the ID may be given for distinguishing the speaking persons.

The controller may correct the length of the voice input by a user to correspond to the voice information stored in the memory.

The display apparatus may comprise a main device comprising the voice output unit and the image output unit; and the display apparatus may further include a sub device including the voice storage and is separately placed outside the main device allowing communication with the main device.

The sub device may further include an auxiliary image output unit to display the subtitle information while reproducing the contents.

The selector may be integrated as part of the sub device.

According to another aspect of the present invention, there is provided a method of controlling a display apparatus, the method including: receiving and storing a voice of a user; and outputting selectively one of voice information and the stored voice of a user when reproducing contents with the voice information.

The method may further include selecting one of the voice information and the stored voice of a user before reproducing the contents.

The method may further include displaying subtitle information corresponding to the voice information when reproducing the contents.

The contents may include contents for studying a foreign language.

The subtitle information and the voice information may include identification (ID) given for distinguishing a unit of words or sentences; and the voice of a user may be received and stored in correspondence to the ID.

The subtitle information and the voice information may include a plurality of conversations between speaking persons; and the ID may be given for distinguishing the speaking persons.

The method may further include correcting the length of the voice input by a user to correspond to the voice information.

The display apparatus may include a main device including a voice output unit to output the voice information and an image output unit to output the subtitle information; and a sub device including a voice storage to receive and store the voice of a user and separately placed outside the main device making communication with the main device possible.

The sub device may further include an auxiliary image output unit to display the subtitle information while reproducing the contents.

The sub device may further including a selector to select one of the voice information and the stored voice of a user.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a view of showing a configuration of a display apparatus according to a first exemplary embodiment of the present invention;

FIG. 2 is a block diagram of the display apparatus according to the first exemplary embodiment of the present invention;

FIG. 3 is a control flowchart of the display apparatus according to the first exemplary embodiment of the present invention;

FIG. 4 is a view of showing a configuration of a display apparatus according to a second exemplary embodiment of the present invention;

FIG. 5 is a block diagram of the display apparatus according to the second exemplary embodiment of the present invention; and

FIGS. 6A and 6B are control flowcharts of the display apparatus according to the second exemplary embodiment of the present invention.

### DETAILED DESCRIPTION OF EXEMPLARY EMBODIMENTS OF THE INVENTION

Below, exemplary embodiments of the present invention will be described in detail with reference to accompanying drawings so as to be easily practiced by a person having ordinary knowledge in the art. The present invention may be exemplarily embodied in various forms without being limited to the exemplary embodiments set forth herein. Descriptions of known parts are omitted for clear explanation, and like reference numerals refer to like elements throughout.

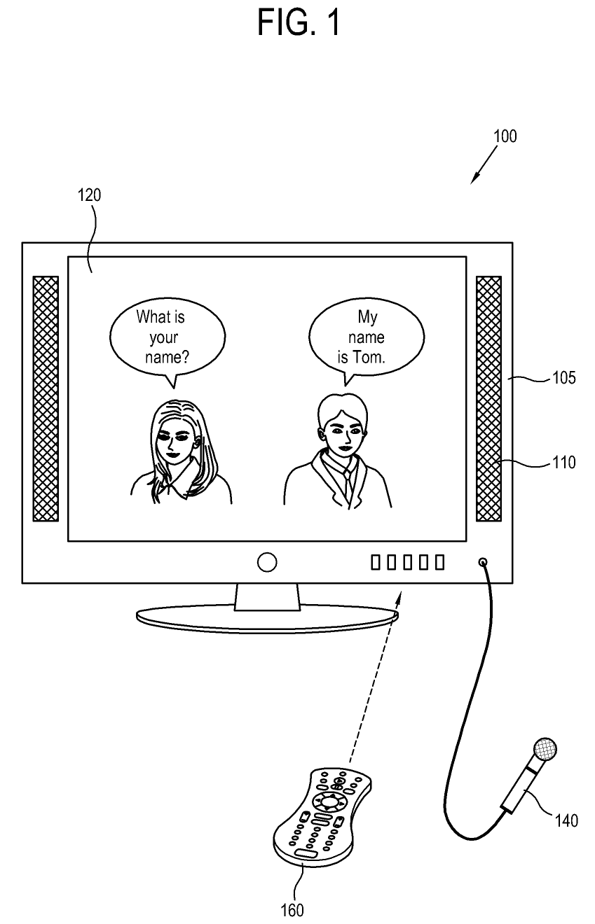

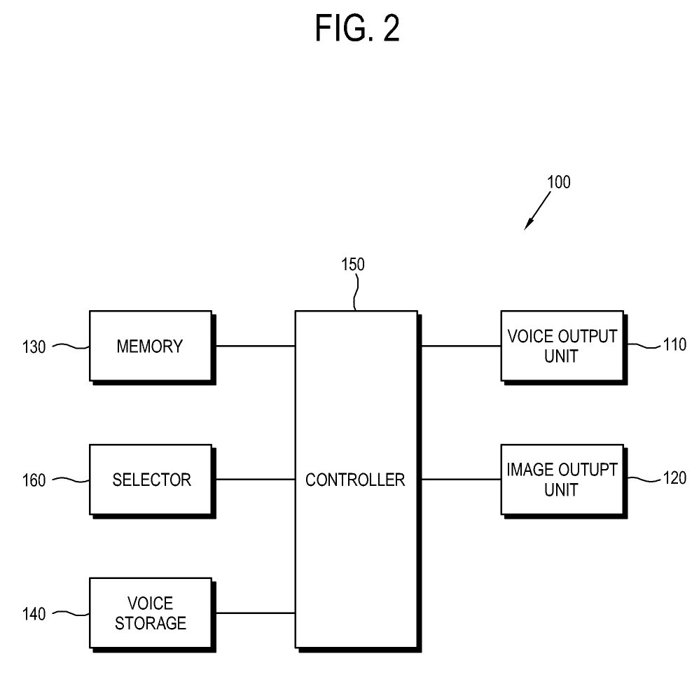

Referring to FIGS. 1 and 2, a first exemplary embodiment of the present invention will be described in more detail. In the following exemplary embodiments, contents are related to contents for studying a foreign language by way of example, but not limited thereto and may be various contents which output voice information and subtitle information, such as karaoke contents, movie contents, game contents, etc.

A display apparatus 100 according to this exemplary embodiment includes a voice output unit 110 to output a voice; an image output unit 120 to output an image; a memory 130 to store contents having voice information; a voice storage 140 to receive and store a voice of a user; and a controller 150 to control the voice output unit 110 to selectively output either of the voice information stored in the memory 130 or the voice of a user stored in the voice storage 140 when reproducing the contents.

In this exemplary embodiment, the display apparatus 100 is achieved by a television (TV) or a monitor.

The image output unit 120 is achieved by a display panel such as a liquid crystal display (LCD), a plasma display panel (PDP) or the like accommodated in a casing 105. Under control of the controller 150, the image output unit 120 receives the contents stored in the memory 130 or an external video signal to thereby output an image and/or a subtitle.

The image output unit 120 may be provided with a video encoder (not shown) and a graphic engine (not shown). The video encoder encodes a video signal output from the graphic engine and outputs it to the outside.

The video signal may include a television video signal like a composite video blanking sync (CVBS) or a video graphic array (VGA) signal.

The graphic engine is provided with various controllers to process a video signal containing video data for karaoke, video data for studying a foreign language, video data for a game, etc.; a subtitle signal; and a video signal such as a moving picture signal for study, etc., and processes the video signal. Further, the graphic engine may be provided with a controller to process national television system committee (NTSC)/PAL (phase-alternating line), VGA, and Canada radio-television and telecommunications commission (CRTC) signals. Also, the graphic engine may be provided with a text frame to display a subtitle, a video digital-to-analog converter (DAC) to display a background image, and an overlay controller to display the background image and the subtitle or words overlapped with each other.

The voice output unit 110 is achieved by a speaker to output an audio signal. Under control of the controller 150, the voice output unit 110 receives a user's voice stored in the voice storage 140, contents stored in the memory 130 or an external voice signal and outputs the user's voice or the voice signal. The voice output unit 110 may be placed inside the casing 105 or separately placed in the outside. The voice output unit 110 connects with a speaker or an earphone, thereby outputting a voice.

The memory 130 stores various software for operating the controller 150, i.e., an audio file, contents such as flash animation and moving picture files, an operating system, back up data, etc. The memory 130 includes a main memory (not shown) with at least one random access memory (RAM); a storage memory (not shown) with at least one read only memory (ROM) including a flash memory; and a backup memory (not shown) for backing up data. The memory connects with the controller 150 allowing data communication therebetween.

In this exemplary embodiment, the contents are for studying a foreign language, which include voice information and video information with subtitle information. The contents are previously stored in the memory 130 when released. Alternatively, the contents may be downloaded by a user through Internet or the like and then stored in the memory 130. Further, a user may download the contents from a server (not shown) connected to the controller 150 and then store it in the memory 130.

The contents may contain a plurality of words, a plurality of sentences, a plurality of conversations between speaking persons.

In the voice information and the subtitle information contained in the contents, identification (ID) may be given to each word or each sentence to distinguish between the word and the sentence. As described above, if the subtitle information and the voice information constitute the plurality of conversations between people, the ID may be assigned for distinguishing the speaking persons.

The voice storage 140 receives and stores a user's voice. Here, the voice storage 140 may be provided in the memory 130.

The voice storage 140 stores a voice input through an external microphone or an internal microphone.

When inputting a voice, a user may input the voice according to each ID. Specifically, if the ID is assigned according to the respective sentences, a user may input the voice according to the sentence. Further, if the ID is assigned according to the speaking persons, the whole voice information of the speaking person may be input in sequence.

When reproducing contents, the controller 150 controls the voice output unit 110 to selectively output one of the voice information stored in the memory 130 or the voice of a user stored in the voice storage 140. Also, the controller 150 controls the image output unit 120 to display the subtitle information when reproducing the contents.

Meanwhile, the display apparatus 100 according to this exemplary embodiment may further include a selector 160 to select one of the voice information stored in the memory or the voice of a user stored in the voice storage before reproducing the contents.

The selector 160 is achieved by a button provided in a remote controller or a casing. However, if the image output unit 120 is provided as a tablet pad, the image output unit 120 may have the function of the selector 160.

Here, a method of inputting the voice of a user is as follows.

A user selects the ID of the contents, and inputs the voice corresponding to the subtitle information through the voice storage 140. Here, a user selects the ID through the selector 160 while reproducing the contents. In this case, the contents are paused, and the voice of a user is input through the voice storage 140. Then, the voice storage 140 stores the input voice of a user.

A user may listen to the input voice by reproducing it, and delete the stored voice. Further, the voice of a user may be input again. Thus, a user may input his/her voice again until a desired voice is input.

In the meantime, a user may input his/her voice by searching and selecting the ID through the selector 160 without reproducing the contents.

Further, the controller 150 may correct the length of a user's voice input corresponding to the voice information stored in the memory 130. For example, if the length of the voice information corresponding to the ID selected by a user is 10 seconds but the length of a user's input voice is 12 seconds, the controller 150 may correct the length of the user's input voice into 10 seconds. On the other hand, if the length of the voice information corresponding to the ID selected by a user is 10 seconds but the length of a user's input voice is 8 seconds, the controller 150 may correct the length of the user's input voice into 10 seconds.

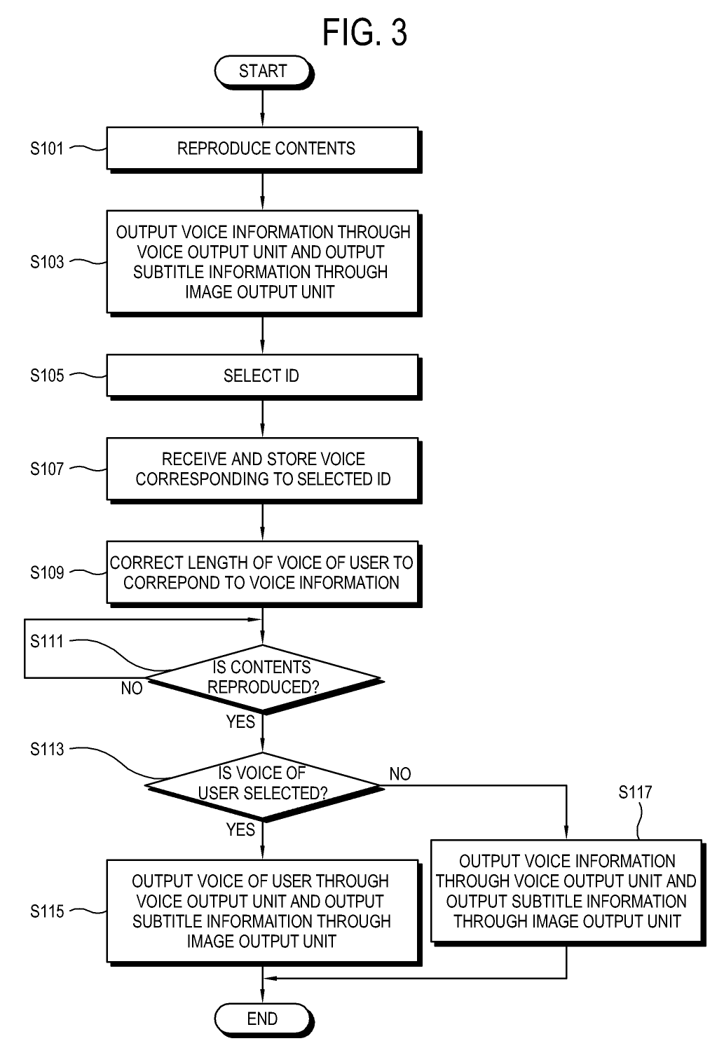

Hereinafter, a control method of the display apparatus 100 according to the first exemplary embodiment of the present invention will be described in more detail with reference to FIG. 3.

First, at operation S101 a user manipulates the selector 160 to reproduce the contents. At operation S103, the controller controls the voice output unit 110 to output the voice information stored in the memory 130, and controls the image output unit 120 to output the video information with the subtitle information.

At operation S105, a user selects the ID through the selector 160 while the contents are reproduced. Then, at operation S107, a user inputs his/her voice corresponding to the selected ID through the voice storage 140, and the input voice of a user is stored in the voice storage 140.

At operation S109, the controller 150 compares the voice information stored in the memory 130 and the input voice of a user with respect to the length, and corrects the length of a user's input voice to correspond to the voice information stored in the memory 130 if they are different in the length.

Then, at operation S111, the controller 150 determines whether a command of reproducing the contents is input. When the command is input to reproduce the contents, at operation S113 it is determined whether the command of reproducing the contents is input with the voice of a user.

In the operation S111, if it is determined that there is no input of the command to reproduce the contents, the controller 150 is on standby until the command of reproducing the contents is input, or repeats the operation s111.

If the command of reproducing the contents is input with the voice of a user in the operation S113, at operation S115 the controller 150 controls the voice output unit 110 to output the input voice of a user and controls the image output unit 120 to output the subtitle information corresponding to the voice.

On the other hand, if the command of reproducing the contents is not input with the voice of a user in the operation S113, at operation S117 the controller controls the voice output unit 110 to output the voice information stored in the memory 130, and controls the image output unit 120 to output the subtitle information corresponding to the voice information.

Further, the operation S113 for determining whether the command of reproducing the contents is input with the voice of a user may be replaced by selecting whether to reproduce the contents with the voice of a user or the voice information stored in the memory 130.

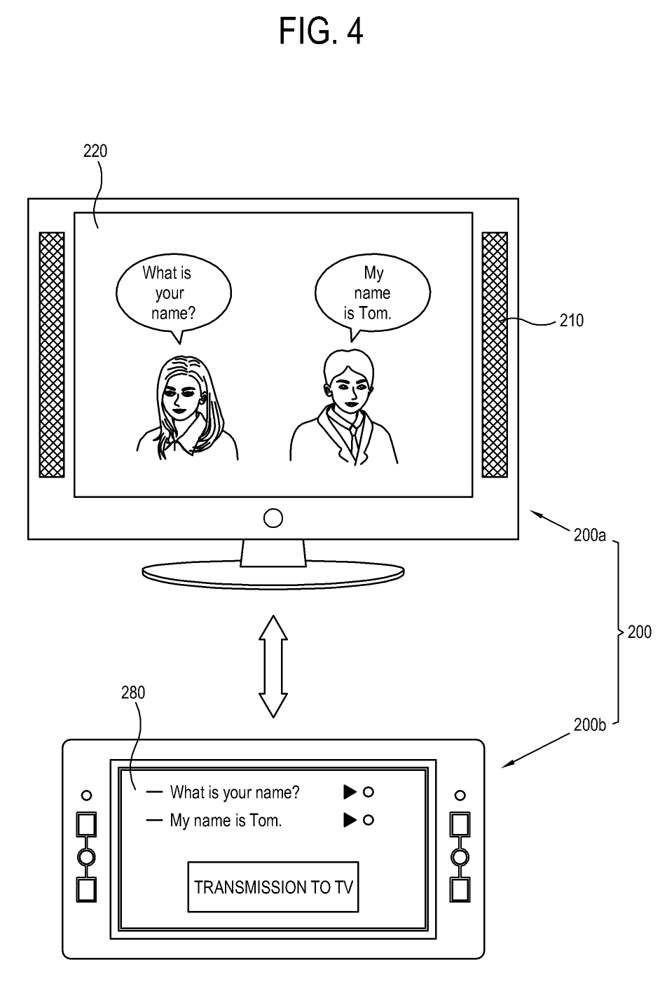

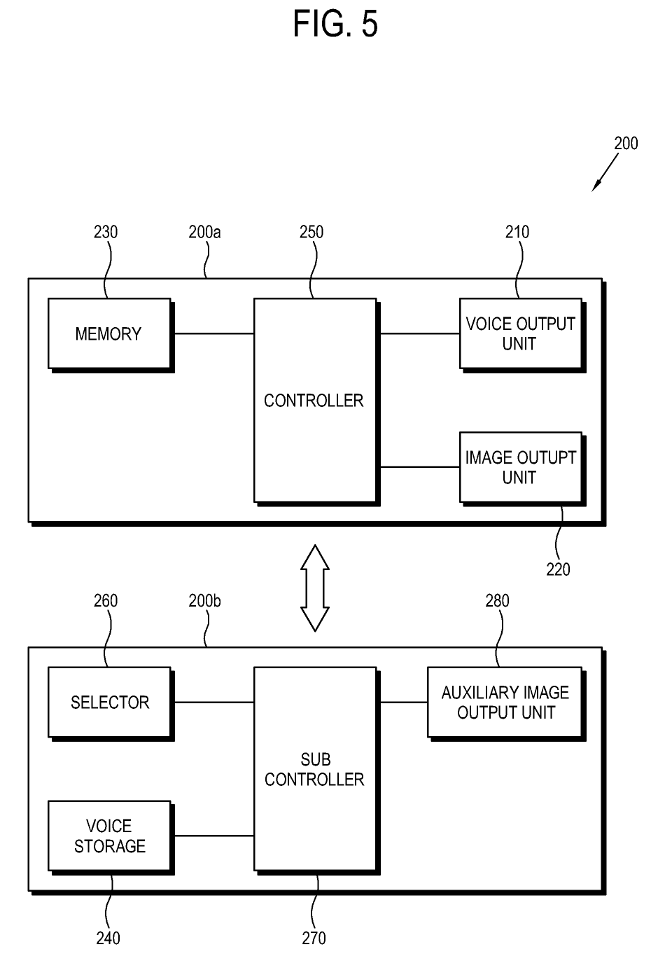

Hereinafter, a second exemplary embodiment of the present invention will be described with reference to FIGS. 4 and 5. In describing the second exemplary embodiment, the detailed description of the same configurations as those employed in the first exemplary embodiment will be omitted.

A display apparatus 200 according to this exemplary embodiment includes a main device 200a and a sub device 200b.

The main device 200a includes a voice output unit 210 and an image output unit 220.

The sub device 200b includes a voice storage 240 and is separately provided outside the main device 200a allowing communication with each other. Here, the sub device 200b includes a sub controller 270 capable of communicating with a controller 250 of the main device 200a.

The communication between the main device 200a and the sub device 200b may employ one digital wireless communication method selected among a wireless local area network (LAN), Bluetooth, zigbee and binary code division multiple access (CDMA). Alternatively, another digital wireless communication method may be usable. Besides, the main device 200a and the sub device 200b may be connected by a wire.

In the case of a multimedia signal such as a voice or a moving picture, its information has to be transmitted in real time without time delay, contrary to other data information. Therefore, it is important to not only make transmission speed higher but also secure a constant transmission speed in transmitting the multimedia signal.

The wireless LAN or Bluetooth are known to those skilled in the art, and thus descriptions thereof will be omitted.

Zigbee is one among standards of institute of electrical and electronics engineers (IEEE) 802.15.4, which support a short range communication. This is technology for the short range communication about 10˜20 m and Ubiquitous computing in the fields of wireless network for a home, an office, etc. That is, Zigbee has a concept of a mobile phone or a wireless LAN, which is different from the existing technology in that the quantity of information to be transmitted is made small instead of minimizing power consumption, and utilized for an intelligent home network, automation of an industrial base and a communication market of short range, physical distribution, environment monitoring, a human interface, telematics, and the military. Since Zigbee is small and inexpensive and consumes low power, it has recently attracted attention as a Ubiquitous constructing solution for a home network or the like.

The CDMA system secures orthogonality between channels by multiplying each of input signals by orthogonal codes different from each other to transmit various input signals simultaneously, and combines all channel signals, thereby transmitting them at the same time. The transmitted signal is multiplied by the same code as the orthogonal code used in a receiving terminal at transmission, thereby taking auto-correlation and reproducing information of each channel. Like this, if different channels are combined and transmitted simultaneously, the combined signals are changed into multilevel signals even though the channel signals individually have a binary waveform.

A binary CDMA method secures a constant speed per user and transmits the voice information at a low cost as compared with the existing CDMA method, so that it can be applied to a universal multimedia transmission system such as wire voice transmission, a wireless voice over internet protocol (VoIP) phone, a wireless image transmission device for a wall-mount type television, or etc.

In particular, the binary CDMA method enables transmission and reception by changing the multilevel signal into the binary waveform, so that a structure of a transmitting/receiving system can become simple remarkably, and the binary CDMA has been known as it is effective in voice, audio and video or the like multimedia transmission.

In this exemplary embodiment, the memory 230 is mounted to the main device 200a. Alternatively, the memory 230 may be mounted to the sub device 200b.

Further, the selector 260 may be provided in the sub device 200b. The selector 260 may function as a remote controller of the main device 200a.

The voice storage 240 may be provided inside the sub device 200b.

The sub device 200b may include an auxiliary image output unit 280 to receive and display subtitle information from the main device 200a when contents are reproduced.

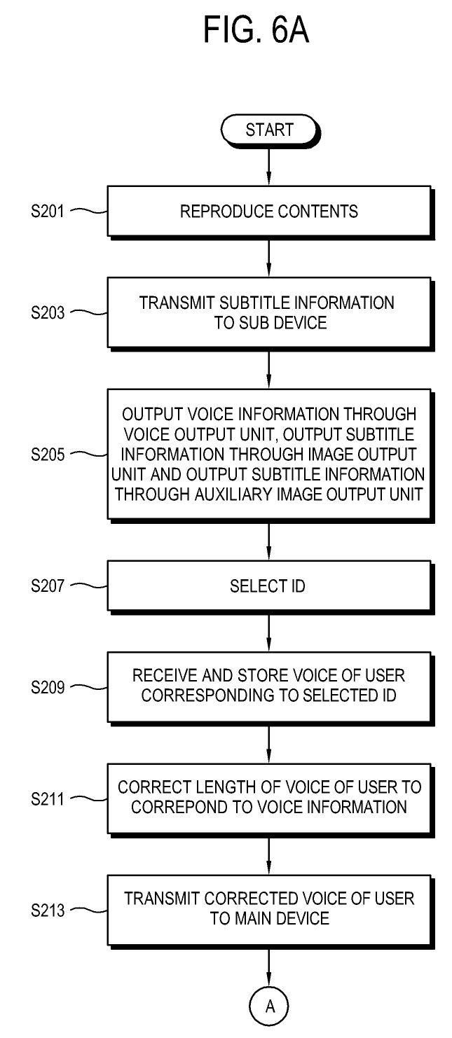

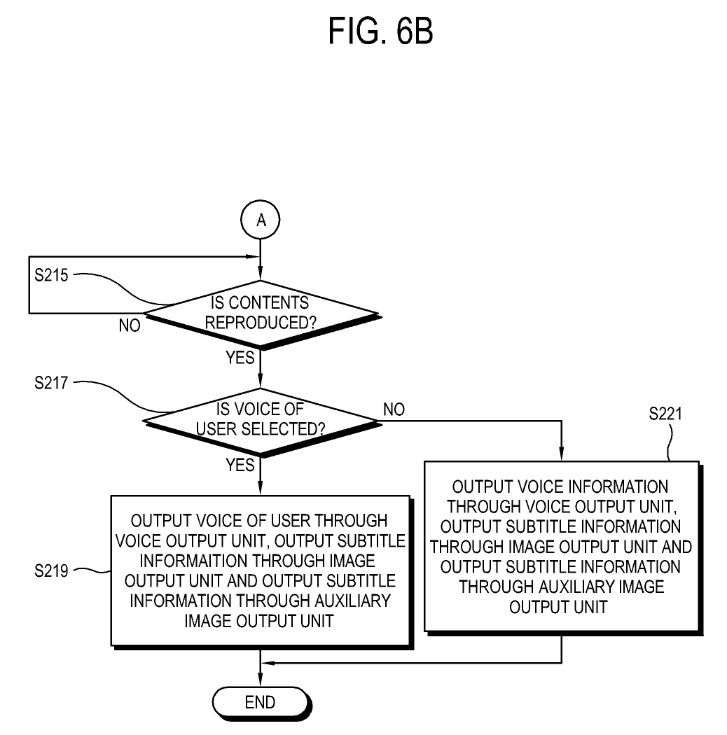

Hereinafter, a control method of the display apparatus 200 according to the second exemplary embodiment of the present invention will be described in more detail with reference to FIGS. 6A and 6B.

First, at operation S201 a user manipulates the selector 260 to reproduce the contents. At operation S203, the controller 250 outputs and transmits subtitle information to the sub device 200b. At operation S205, the controller 250 controls the voice output unit 210 to output the voice information stored in the memory 230, and the image output unit 220 to output the video information with the subtitle information. Further, in the operation S205, the sub device 200b outputs the subtitle information from the main device 200a to the auxiliary image output unit 280.

At operation S207, a user selects the ID through the selector 260 while the contents are reproduced. Then, at operation S209, a user inputs his/her voice corresponding to the selected ID through the voice storage 240, and the input voice of a user is stored in the voice storage 240.

At operation S211, the controller 250 compares the voice information stored in the memory 230 and the input voice of a user with respect to the length, and corrects the length of a user's input voice to correspond to the voice information stored in the memory 230 if they are different in the length.

Next, at operation S213, the corrected voice of a user is transmitted to the main device 200a.

At operation S215, the controller 250 determines whether a command of reproducing the contents is input. When the command is input to reproduce the contents, at operation S215 it is determined whether the command of reproducing the contents is input with the voice of a user.

In the operation S215, if it is determined that there is no input of the command to reproduce the contents, the controller 250 is on standby until the command of reproducing the contents is input, or repeats the operation s215.

If the command of reproducing the contents is input with the voice of a user in the operation S217, at operation S219 the controller 250 controls the voice output unit 210 to output the input voice of a user and controls the image output unit 220 to output the subtitle information corresponding to the voice. In the operation S219, the sub device 200b outputs the subtitle information from the main device 200a to the auxiliary image output unit 280.

On the other hand, if the command of reproducing the contents is not input with the voice of a user in the operation S217, at operation S221 the controller 250 controls the voice output unit 210 to output the voice information stored in the memory 230, and controls the image output unit 220 to output the subtitle information corresponding to the voice information. In the operation S221, the sub device 200b outputs the subtitle information from the main device 200a to the auxiliary image output unit 280.

As apparent from the above description, the present invention provides a display apparatus and a control method thereof, which can record a user's voice and output the voice as being mixed with contents, and thus in a particular case of contents related to language study, educational effect and interest of a user can be increased.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

1. A display apparatus comprising:
a memory which stores contents with voice information stored;
a voice output unit which outputs a voice;
a voice storage which receives and stores a voice of a user; and
a controller which controls the voice output unit to selectively output one of the voice information stored in the memory and the voice of a user stored in the voice storage when reproducing the contents.

2. The display apparatus according to claim 1, further comprising a selector to select one of the voice information stored in the memory and the voice of a user stored in the voice storage before reproducing the contents.

3. The display apparatus according to claim 2, wherein the memory further stores subtitle information corresponding to the voice information; and
the display apparatus further comprises an image output unit which displays the subtitle information when reproducing the contents.

4. The display apparatus according to claim 3, wherein the contents comprise contents for studying a foreign language.

5. The display apparatus according to claim 4, wherein the subtitle information and the voice information comprise identification (ID) given for distinguishing a unit of words or sentences; and
the controller controls the voice storage to store the voice of a user in correspondence to the ID.

6. The display apparatus according to claim 5, wherein the subtitle information and the voice information comprise a plurality of conversations between speaking persons; and
the ID is given for distinguishing the speaking persons.

7. The display apparatus according to claim 5, wherein the controller corrects the length of the voice input by a user to correspond to the voice information stored in the memory.

8. The display apparatus according to claim 3, wherein a main device comprises the voice output unit and the image output unit; and
the display apparatus further comprises a sub device which comprises the voice storage and is separately placed outside the main device allowing communication with the main device.

9. The display apparatus according to claim 8, wherein the main device further comprises the controller and the memory.

10. The display apparatus according to claim 8, wherein the sub device further comprises an auxiliary image output unit to display the subtitle information while reproducing the contents.

11. The display apparatus according to claim 8, wherein the selector is integrated as part of the sub device.

12. A method of controlling a display apparatus, comprising:
receiving and storing a voice of a user; and
outputting selectively one of voice information and the stored voice of a user when reproducing contents with the voice information.

13. The method according to claim 12, further comprising selecting one of the voice information and the stored voice of a user before reproducing the contents.

14. The method according to claim 13, further comprising displaying subtitle information corresponding to the voice information when reproducing the contents.

15. The method according to claim 14, wherein the contents comprise contents for studying a foreign language.

16. The method according to claim 15, wherein the subtitle information and the voice information comprise identification (ID) given for distinguishing a unit of words or sentences; and
the voice of a user is received and stored in correspondence to the ID.

17. The method according to claim 16, wherein the subtitle information and the voice information comprise a plurality of conversations between speaking persons; and
the ID is given for distinguishing the speaking persons.

18. The method according to claim 16, further comprising correcting the length of the voice input by a user to correspond to the voice information.

19. The method according to claim 14, wherein the display apparatus comprises:
a main device comprising a voice output unit to output the voice information and an image output unit to output the subtitle information; and
a sub device comprising a voice storage to receive and store the voice of a user and separately placed outside the main device making communication with the main device possible.

20. The method according to claim 19, wherein the sub device further comprises an auxiliary image output unit to display the subtitle information while reproducing the contents.

21. The method according to claim 19, wherein the sub device further comprises a selector to select one of the voice information and the stored voice of a user.

22. A display apparatus comprising:
a controller which controls a voice output unit to selectively output one of the voice information stored in a memory and a voice of a user stored in a voice storage when reproducing contents.

23. The display apparatus according to claim 22, wherein the memory stores contents with the voice information.

24. The display apparatus according to claim 22, wherein the voice storage receives and stores the voice of the user.

25. The display apparatus according to claim 22, wherein the contents comprise contents for studying a foreign language.
